(19) United States
(12) Patent Application Publication
(10) Pub. No.: US 2008/0309975 A1
(43) Pub. Date: Dec. 18, 2008

(54) CONTROLLING IMAGE FORMING OPERATION

(76) Inventor: Hiroshi Kondoh, Yokohama-shi (JP)

Correspondence Address: DICKSTEIN SHAPIRO LLP, 1825 EYE STREET NW, Washington, DC, 20006-5403, US

(21) Appl. No.: 12/141,852

(22) Filed: Jun. 18, 2008

(30) Foreign Application Priority Data
Jun. 18, 2007 (JP) 2007-160535

(51) Int. Cl. G06F 3/12

(52) U.S. Cl. 358/1.15

(57) ABSTRACT

When printing job notice information is received from an information processing apparatus and a printing job execution instruction is received from a user, an image forming apparatus generates printing job generation information based on whether the printing job execution instruction matches the printing job notice information. Based on the printing job generation information, the information processing apparatus determines whether to generate the printing job.

### CROSS-REFERENCE TO RELATED APPLICATIONS

This patent application is based on and claims priority under 35 U.S.C. § 119 to Japanese Patent Application No. 2007-160535, filed on Jun. 18, 2007, in the Japanese Patent Office, the disclosure of which is hereby incorporated by reference.

### FIELD OF THE INVENTION

Example embodiments of the present invention relate to an apparatus, method, system, computer program and product, each capable of controlling an image forming operation, and more specifically to controlling an image forming operation with improved security.

### BACKGROUND

An image forming apparatus, such as a printer, is usually shared by a plurality of information processing apparatuses, each of which is connected to the image forming apparatus via a network. When the image forming apparatus receives a printing job from the information processing apparatus, the image forming apparatus outputs a printed document onto the output tray. When the image forming apparatus is provided in the public place, the user at the information processing apparatus is encouraged to pick up the printed document in a timely manner for improved security. However, it has been difficult to supervise the behavior of each individual user.

In order to solve the above-described limitation, an image forming apparatus may be provided, which outputs a printed document only when a user input, such as a password previously set by the user, is received at the image forming apparatus, for example, as described in the Japanese Patent Application Publication Nos. H09-244828 and H08-107504.

While the technique described in the Japanese Patent Application Publication Nos. H09-244828 and H08-107504 may be able to provide the image forming system with improved security, the memory space of the image forming apparatus or a file server connected to the image forming apparatus may not be efficiently used. For example, a printing job generated by the information processing apparatus is kept in the memory of the image forming apparatus or the file server until the printing job is processed according to the user input or until the printing job is cancelled according to the user input. Further, keeping the printing job, which may include confidential data, in the image forming apparatus or the file server may not be desirable even when the access to the image forming apparatus or the file server is restricted.

### SUMMARY

Example embodiments of the present invention include an apparatus, method, system, computer program and product each capable of controlling operation of image forming.

Example embodiments of the present invention include an image forming apparatus, which includes a network interface to receive printing job notice information from an outside apparatus via a network, the printing job notice information being generated by the outside apparatus when a user instruction for generating a printing job is received at the outside apparatus; a user interface to receive a printing job execution instruction from a user; and a controller to determine whether the printing job execution instruction matches the printing job notice information to generate a first determination result, generate printing job generation information including a message that indicates whether to generate the printing job based on the first determination result, and send the printing job generation information to the outside apparatus via the network.

The controller may further determine whether the printing job execution instruction is received within a time period set by timeout information, which is obtained as a part of the printing job notice information, to generate a second determination result. The printing job generation information may be generated based on the second determination result in addition to the first determination result

Example embodiments of the present invention include an information processing apparatus, which includes a processor, a storage device, and a user interface. The storage device stores a plurality of instructions, which causes when executed the processor to display on the user interface at least one of a plurality of sections including: a first section allowing the user to select the security printing function; a second section allowing the user to input user authentication information; a third section allowing the user to select the timeout function; and a fourth section allowing the user to input timeout information. When a user instruction for generating a printing job is received, for example, through the user interface, the processor may send printing job notice information including information regarding the at least one of a plurality of sections being displayed. The above-described plurality of instructions may be stored in any desired recording medium.

Example embodiments of the present invention include an image forming system including an image forming apparatus and an information processing apparatus that may be communicated through a network. The information processing apparatus sends printing job notice information when a user instruction for generating a printing job is received. The image forming apparatus receives the printing job notice information from the information processing apparatus and a printing job execution instruction from a user, and determines whether the printing job execution instruction matches the printing job notice information to generate a first determination result. The image forming apparatus further generates printing job generation information including a message that indicates whether to generate the printing job based on the first determination result, and sends the printing job generation information to the information processing apparatus.

Example embodiments of the present invention include a method of controlling an image forming system, which includes: sending printing job notice information from an information processing apparatus to an image forming apparatus when a user instruction for generating a printing job is received at the information processing apparatus; receiving at the image forming apparatus a printing job execution instruction from a user; generating at the image forming apparatus printing job generation information, the printing job information including a message that indicates whether to generate the printing job based on a first determination result, the first determination result indicating whether the printing job execution instruction matches the printing job notice information; generating at the information processing apparatus the printing job based on the printing job generation information; and forming at the image forming apparatus an image according to the printing job.

In addition to the above-described example embodiments, the present invention may be practiced in various other ways.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating the configuration of an image forming system, according to an example embodiment of the present invention;

FIG. 2 is a schematic diagram illustrating the structure of an image forming apparatus shown in FIG. 1 according to an example embodiment of the present invention;

FIG. 3 is a schematic diagram illustrating the structure of an information processing apparatus shown in FIG. 1 according to an example embodiment of the present invention;

FIG. 4 is a data flow diagram illustrating operation of generating and processing a secured printing job, performed by the image forming system of FIG. 1, according to an example embodiment of the present invention;

FIG. 5 is a flowchart illustrating operation of generating a printing job, performed by the information processing apparatus shown in FIG. 1, according to an example embodiment of the present invention;

FIG. 6 is an illustration of an example printer dialog, displayed by the information processing apparatus shown in FIG. 1;

FIG. 7 is an illustration of an example printer driver dialog, displayed by the information processing apparatus shown in FIG. 1;

FIG. 8 is an illustration of an example confirmation dialog, displayed by the information processing apparatus shown in FIG. 1;

FIG. 9 is a flowchart illustrating operation of processing a secured printing job, performed by the image forming apparatus shown in FIG. 1, according to an example embodiment of the present invention;

FIG. 10 is an example table storing a notice ID, provided in the image forming apparatus shown in FIG. 1;

FIG. 11 is a data flow diagram illustrating operation of generating and processing a secured printing job, performed by the image forming system shown in FIG. 1, according to an example embodiment of the present invention;

FIG. 12 is an illustration of an example printer driver dialog, displayed by the information processing apparatus shown in FIG. 1;

FIG. 13 is a flowchart illustrating operation of generating a printing job, performed by the information processing apparatus shown in FIG. 1, according to an example embodiment of the present invention;

FIG. 14 is an illustration of a confirmation dialog, displayed by the information processing apparatus shown in FIG. 1;

FIG. 15 is a flowchart illustrating operation of processing a secured printing job, performed by the image forming apparatus shown in FIG. 1, according to an example embodiment of the present invention;

FIG. 16 is a data flow diagram illustrating operation of generating and processing a secured printing job, performed by the image forming system shown in FIG. 1, according to an example embodiment of the present invention;

FIG. 17 is a flowchart illustrating operation of processing a secured printing job, performed by the image forming apparatus shown in FIG. 1, according to an example embodiment of the present invention; and

FIG. 18 is an illustration of a confirmation dialog, displayed by the information processing apparatus shown in FIG. 1.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

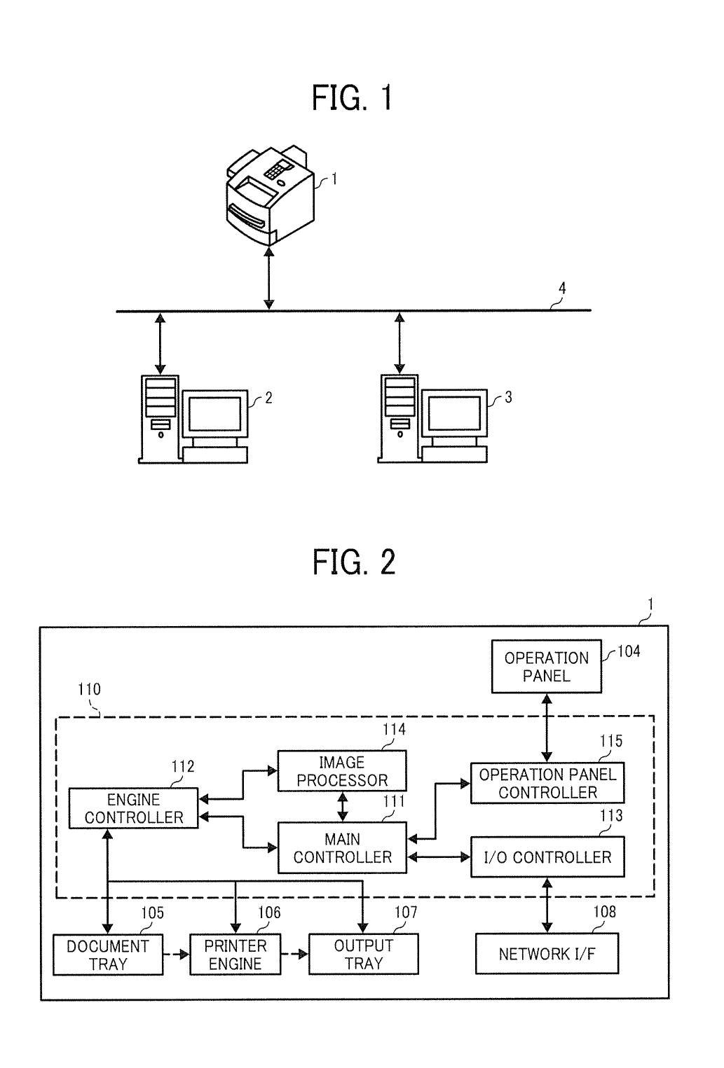

Referring now to FIG. 1, an image forming system is explained according to an example embodiment of the present invention. The image forming system of FIG. 1 includes an image forming apparatus 1, an information processing apparatus 2, and an information processing apparatus 3, which are connected with one another via a network 4. In this example, the image processing apparatuses 2 and 3 may each be implemented by any desired apparatus capable of generating a printing job. The image forming apparatus 1 may be implemented by any desired apparatus capable of forming an image according to the printing job generated by the information processing apparatus 2 or 3. The network 4 may be implemented by any desired network such as a local area network (LAN), a wide area network (WAN), or the Internet. The network 4 may be entirely or partially wireless.

In one example operation, when a secured printing function is not selected, the information processing apparatus 2 or 3 may generate a printing job according to a user instruction and send the printing job to the image forming apparatus 1. The image forming apparatus 1 receives the printing job, and processes the printing job to output a printed document.

In another example operation, when the secured printing function is selected, the information processing apparatus 2 or 3 may generate printing job notice information according to a user instruction and send the printing job notice information to the image forming apparatus 1. The image forming apparatus 1 receives the printing job notice information, and waits for a user input. When the user input is detected, the image forming apparatus 1 determines whether the user input matches the printing job notice information to generate a determination result. The image forming apparatus 1 generates printing job generation information based on the determination result, and sends the printing job generation information to the information processing apparatus 2 or 3. The information processing apparatus 2 or 3 analyzes the printing job generation information being received to determine whether to generate a printing job. When generated, the printing job is sent to the image forming apparatus 1. The image forming apparatus 1 receives the printing job, and processes the printing job to output a printed document.

The image forming system of FIG. 1 may be implemented in various other ways. For example, a file server may be additionally provided on the network 4. The file server may store one or more printing jobs, which may be generated by the information processing apparatus 2 or 3.

In one example operation, when the secured printing function is selected, the information processing apparatus 2 or 3 may generate printing job notice information and a printing job according to a user instruction. The information processing apparatus 2 or 3 may send the printing job notice information to the image forming apparatus 1. The information processing apparatus 2 or 3 may send the printing job to the file server. The image forming apparatus 1 receives the printing job notice information, and waits for a user input. When the user input is detected, the image forming apparatus 1 determines whether the user input matches the printing job notice information to generate a determination result. The image forming apparatus 1 generates printing job generation information based on the determination result, and sends the printing job generation information to the file server. The file server analyzes the printing job generation information being received to determine whether to send the printing job to the image forming apparatus 1. When the printing job is received, the image forming apparatus 1 processes the printing job to output a printed document. For improved security, the file server may encrypt the printing job when storing the printing job, and decrypt the printing job being encrypted before sending the printing job to the image forming apparatus.

In this example, the image forming apparatus 1 is implemented by a printer capable of processing a printing job, which is received from the information processing apparatus 2 or 3 through the network 4. Further, the information processing apparatus 2 and 3 are each implemented by a computer capable of generating a printing job and transmitting the printing job to the image forming apparatus 1 via the network 4.

Referring now to FIG. 2, a hardware structure of the image forming apparatus 1 is explained according to an example embodiment of the present invention. The image forming apparatus 1 includes an operation panel 104, a document tray 105, a printer engine 106, an output tray 107, a network interface (I/F) 108, and a controller 110, which may be electrically coupled or connected with one another as the arrows indicate. The controller 110 includes a main controller 111, an engine controller 112, an input/output (I/O) controller 113, an image processor 114, and an operation panel controller 115, which may be connected or coupled via an internal bus. As described below, the image forming apparatus 1 is capable of processing a printing job with the secured printing function or without the secured printing function.

The operation panel 104 may function as a user interface, which allows a user to directly input various information to the image forming apparatus 1, for example, by providing an input device such as various kinds of keys or buttons that may be pressed or selected by the user, a microphone, etc. Alternatively or additionally, the operation panel 104 may function as a user interface, which allows a user to obtain various information output by the image forming apparatus 1, for example, by providing an output device such as a display or a speaker.

In this example, the operation panel 104 may be implemented by a liquid crystal display (LCD) integrated with a touch panel. The touch panel may allow the user to make the selection or instruction according to the contents of the screen displayed by the LCD. The contents of the screen may be controlled by the main controller 111 via the operation panel controller 115. For example, the selection or instruction made by the user may be sent to the main controller 110 via the operation panel controller 115. The main controller 110 analyzes the user input, and changes the contents of the screen according to the user input.

The document tray 105 stores a plurality of recording sheets. The printer engine 106 may include a plurality of devices to be used for forming an image on a recording sheet, which is provided from the document tray 105, according to a user instruction input through the operation panel 104. The printed sheet is output onto the output tray 107.

The network I/F 108 allows the image forming apparatus 1 to communicate with a counterpart apparatus, such as the information processing apparatus 2 or 3, through the network 4. For example, the network I/F 108 may be implemented by a network interface card capable of communicating in compliance with the Ethernet or Universal Serial Bus (USB).

The controller 110 may control operation of the image forming apparatus 1. For example, the controller 110 may be implemented by a processor such as a central processing unit (CPU) provided with a memory. The memory may include a volatile memory such as a dynamic random access memory (DRAM), and a non-volatile memory such as a read only memory (ROM), non-volatile RAM, and/or a hard disk drive (HDD).

The volatile memory may function as a work area of the CPU. The non-volatile memory may store various data including a printing control program to be executed by the CPU. For example, upon activation of the image forming apparatus 100 or upon receiving a request from the user, the CPU may load the printing control program from the non-volatile memory onto the non-volatile memory, and perform printing control operation according to the printing control program. Alternatively, the printing control program may be stored in a removable memory such as an optical disc, and read out by the image forming apparatus 1. In such case, a device, such as a removable memory reader and/or writer, may be additionally provided. Alternatively, the printing control program may be stored in any storage device provided on the network 4, and downloaded by the image forming apparatus 1 via the network 4 through the network I/F 108.

As shown in FIG. 2, the controller 110 may include one or more components depending on the function to be performed. The main controller 111 controls entire operation of the controller 110. The engine controller 112 controls operation of one or more devices used for image forming, such as the printer engine 106. The I/O controller 113 controls transmission or reception of data through the network I/F 108 under control of the main controller 111. The image processor 114 generates print data to be output by the image forming apparatus 1, according to the printing job that may be received from the network I/F 108.

In one example, when the secured printing function is not selected, the image forming apparatus 1 may form an image on a recording sheet according to a printing job received from the information processing apparatus 2 or 3. The network I/F 108 may receive a printing job to be processed, from the information processing apparatus 2 or 3. The I/O controller 113 sends the printing job received by the network I/F 108 to the main controller 111. The main controller 111 causes the image processor 114 to generate print data according to text information or image information obtainable from the printing job. The engine controller 112 causes the devices including the printer engine 106 to perform image forming according to the print data. In this example, an image may be formed with any desired colorant such as ink or toner. The printed document is output to the output tray 107.

In another example, when the secured printing function is selected, the image forming apparatus 1 may receive printing job notice information from the information processing apparatus 2 or 3. When a printing job execution instruction is received from the user, for example, through the operation panel 104, the image forming apparatus 1 may generate printing job generation information, for example, based on comparison between the printing job notice information and the printing job execution instruction. The printing job generation information may be transmitted to the information processing apparatus 2 or 3. When the printing job is received from the information processing apparatus 2 or 3, the image forming apparatus 1 may form an image on a recording sheet according to the printing job in a substantially similar manner as described above.

Alternatively, the image forming apparatus 1 may be implemented in various other ways. For example, the image forming apparatus 1 of FIG. 2 may be additionally provided with the function of scanning an original document into image data. In such case, an automatic document feeder (ADF), a scanner, and/or an output tray may be additionally provided. The ADF may feed an original document, placed on a document tray of the ADF, to an image reading section of the scanner. The scanner reads the original document into image data, which may be provided by the ADF or provided on an exposure glass of the scanner by the user. The original document, which may be read by the scanner, may be output onto the output tray. The image data generated by the scanner may be sent to the image processor 114. The image processor 114 may apply various image processing to the image data, and store the image data on a memory of the image forming apparatus 1. The image data being stored may be further sent to the counterpart apparatus, such as the information processing apparatus 2, via the network 4.

In another example, the image forming apparatus 1 of FIG. 2 may be additionally provided with the function of copying an original document. In such case, an ADF, a scanner, and/or an output tray may be additionally provided. Once the original document is scanned into the image data by the scanner as described above, the image processor 114 may generate print data to be output by the image forming apparatus 1. The engine controller 112 causes the devices including the printer engine 106 to perform image forming according to the print data.

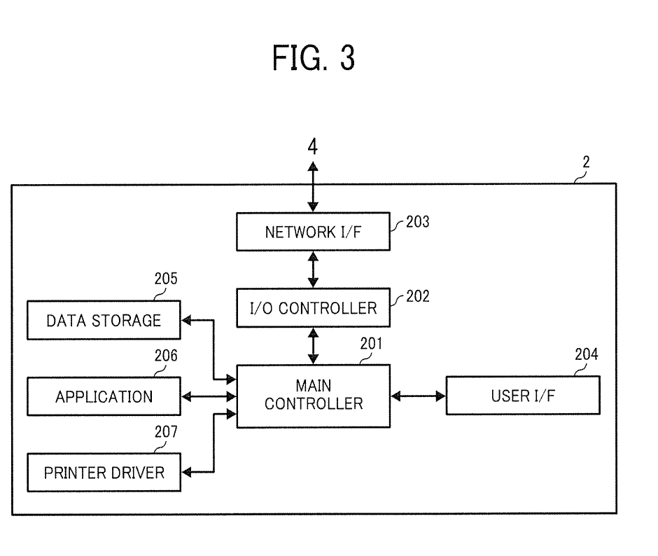

Referring now to FIG. 3, a hardware structure of the information processing apparatus 2 or 3 is explained according to an example embodiment of the present invention. The information processing apparatus 2 or 3 mainly includes a main controller 201, an input/output (I/O) controller 202, a network I/F 203, a user I/F 204, a data storage 205, an application 206, and a printer driver 207.

The main controller 201 controls operation of the information processing apparatus 2 or 3. The main controller 201 may be implemented by a processor provided with a memory, such as a central processing unit (CPU) provided with a ROM and a RAM.

The I/O controller 202 controls communication between the information processing apparatus 2 or 3 and a counterpart apparatus, such as the image forming apparatus 1, via the network 4.

The network I/F 203 may function as an interface, which allows the information processing apparatus 2 or 3 to communicate with a counterpart apparatus via the network 4.

The user I/F 204 may function as an interface, which allows interaction between the information processing apparatus 2 or 3 and the user. The user I/F 204 may be implemented by an input device such as a mouse or a keyboard, and an output device such as a display.

The data storage 205 may store various data. In this example, the data storage 205 may be implemented by any desired non-volatile memory, such as a hard disk drive (HDD).

The application 206 may provide the information processing apparatus 2 or 3 with the function of generating or editing data, such as document data or image data. Examples of the application 206 may include, but not limited to, a word processing program, a drawing program, and a spreadsheet program. The application 206 may be activated by the user at any desired time.

The printer driver 207 may provide the information processing apparatus 2 or 3 with the function of generating a printing job with or without the secured printing function. The printer driver 207 may be stored in a memory, such as the data storage 205, the ROM of the main controller 201, or any other desired memory such as a removable memory or storage provided on the network 4. When the information processing apparatus 2 or 3 is activated, the printer driver 207 may be executed as a background task. In another example, the printer driver 207 may be activated by the user through the application 206 by selecting the function of printing using the user I/F 204.

In one example, when the secured printing function is not selected, the printer driver 207 may generate a printing job, which includes information regarding data to be printed, for example, in a PDL format according to a user instruction. The printing job may be further transmitted to the image forming apparatus 1.

In another example, when the secured printing function is selected, the printer driver 207 may generate printing job notice information according to a user instruction, and send the printing job notice information to the image forming apparatus 1. The printer driver 207 may determine whether to generate the printing job based on printing job generation information received from the image forming apparatus 1. When generated, the printing job may be transmitted to the image forming apparatus 1.

The information processing apparatus 2 or 3 may be implemented in various other ways, for example, as any other desired computer such as notebook computer, personal digital assistant (PDA) device, mobile phone, digital camera, etc.

For the descriptive purpose, throughout the examples described below in this specification, it is assumed that the information processing apparatus 2, which may function as a client apparatus with respect to the image forming apparatus 1, requests the image forming apparatus 1 to process a printing job generated by the information processing apparatus 2.

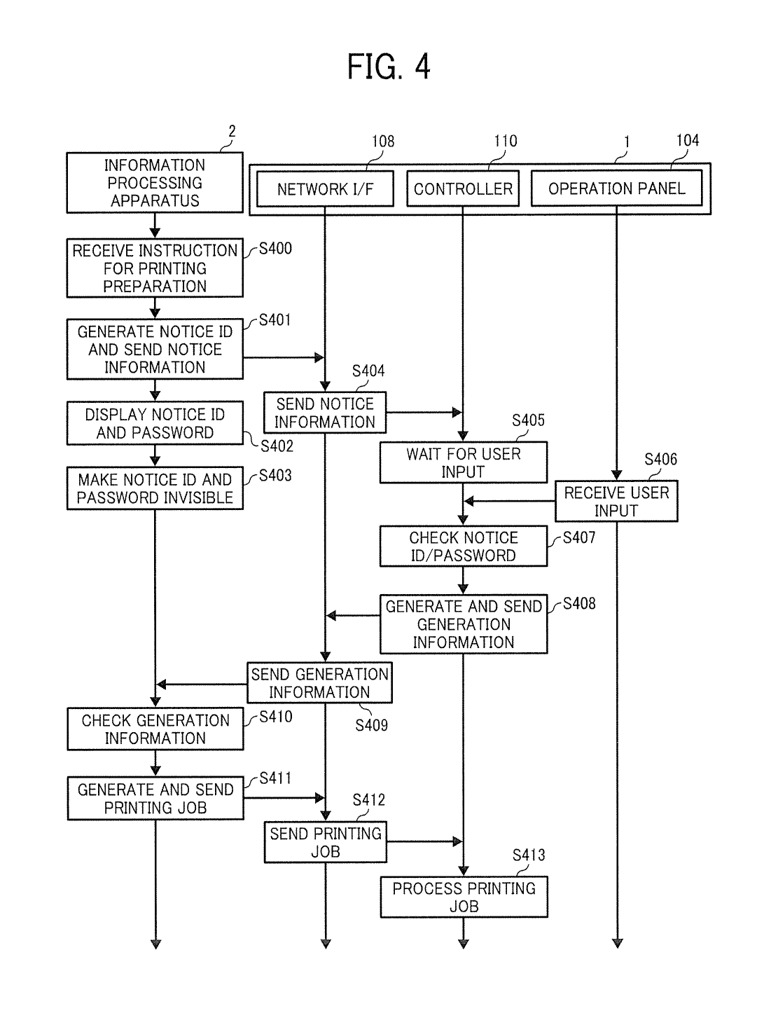

Referring now to FIG. 4, operation of generating a secured printing job and processing the secured printing job, performed by the image forming system of FIG. 1, is explained according to an example embodiment of the present invention.

At S400, the information processing apparatus 2 may receive a user instruction, which requests the printer driver 207 to prepare for printing job generation, through the application 206.

At S401, the information processing apparatus 2 generates a notice ID, and sends printing job notice information to the image forming apparatus 1.

In this example, the printing job notice information includes a command that secured printing is requested, and the notice ID. The notice ID may be generated by the information processing apparatus 2 as job identification information, which is used to identify a printing job to be generated by the information processing apparatus 2. For example, the main controller 201 may be provided with a random sequence generator, which randomly generates a sequence of characters and/or numbers, and uses the generated sequence as a notice ID to be assigned to the corresponding printing job. In another example, the notice ID may be generated as a combination of a sequence of characters and/or numbers randomly generated, and a sequence of characters and/or numbers obtainable from information relating to the printing job. The information relating to the printing job may include information regarding date and/or time when the instruction for printing job generation is input, information regarding the information processing apparatus 2 such as the host ID or the MAC address uniquely assigned to the information processing apparatus 2, information regarding the user, etc.

The printing job notice information may additionally include user identification information, which may be used to identify the user or the information processing apparatus 2 requesting the printing job, such as a user ID, a host ID or host name of the information processing apparatus 2, a network address of the information processing apparatus 2, etc.

The printing job notice information may additionally include printer information, which may be used to identify the image forming apparatus 1 processing the printing job, such as a host ID or host name of the image forming apparatus 1, a network address of the image forming apparatus 1, etc.

The printing job notice information may additionally include user authentication information, which may be used to authenticate the user, for example, a password previously set by the user either through the information processing apparatus 2 or the image forming apparatus 1.

The printing job notice information may additionally include any other desired information relating to the printing job to be generated.

At S402, the information processing apparatus 2 displays the notice ID generated at S401 and the password previously set. Alternatively, the password may not be displayed or may be concealed.

At S403, the information processing apparatus 2 makes the notice ID and the password, which are displayed at S402, to be invisible from the user. The information processing apparatus 2 waits for further processing.

At S404, the image forming apparatus 1 receives the printing job notice information, which is sent from the information processing apparatus 2 at S401, through the network I/F 108. The network I/F 108 sends the printing job notice information to the controller 110.

At S405, the controller 110 receives the printing job notice information, and stores information obtainable from the printing job notice information. For example, the notice ID and the user identification information, which may be obtainable from the printing job notice information, may be stored with information regarding the time when the printing job notice information is received. For example, the controller 110 may convert the contents of the printing job notice information to a format manageable by the controller 110, such as to a secured job table illustrated in FIG. 10. The controller 110 waits until the operation panel 104 receives a user input.

The user, who has obtained information regarding the notice ID and the password from the user I/F 104 at S402, moves to the place where the image forming apparatus 1 is provided. Through the operation panel 104, the user may input the notice ID and the password. At S406, the operation panel 104 receives the user input, which includes information regarding the notice ID and the password, and sends the obtained information to the controller 110. Alternatively, the image forming apparatus 1 may request the user to input either one of the notice ID and the password. Alternatively, the image forming apparatus 1 may request the user to input any other information that may be used to authenticate the user.

When the user input is detected through the operation panel 104, at S407, the controller 110 is activated to check the user input. In one example, the controller 110 may determine whether the notice ID of the user input, which is obtained at S406, matches the notice ID obtained from the printing job notice information, for example, by checking the secured job table to generate a determination result. Additionally or alternatively, the controller 110 may determine whether the password of the user input, which is obtained at S406, matches with the password obtained from the printing job notice information, for example, by checking the secured job table to generate a determination result.

At S408, the controller 110 generates printing job generation information, which indicates whether the printing job should be generated, based on the determination result obtained at S407. When the determination result indicates that the notice ID and/or password of the user input matches the notice ID and/or password of the printing job notice information, the printing job generation information may indicate that the printing job should be generated. When the determination result indicates that the notice ID and/or password of the user input does not match the notice ID and/or password of the printing job notice information, the printing job generation information may indicate that the printing job should not be generated. The controller 110 further sends the printing job generation information to the network I/F 108.

At S409, the network I/F 108 sends the printing job generation information to the information processing apparatus 2 via the network 4.

At S410, the information processing apparatus 2 determines whether to generate the printing job based on the printing job generation information. For example, when the printing job generation information includes a message that indicates to generate the printing job, at S411, the information processing apparatus 2 generates the printing job, and sends the printing job to the image forming apparatus 1. Alternatively, when printing job generation information includes the password of the user input in addition or in alternative to the message, the information processing apparatus 2 may determine whether the password of the user input matches the password previously set by the user. When it is determined that the password matches, at S411, the information processing apparatus 2 generates the printing job, and sends the printing job to the image forming apparatus 1. The printing job includes information regarding data to be output, such as text data and/or image data.

When the network I/F 108 receives the printing job, at S412, the network I/F 108 sends the printing job to the controller 110.

At S413, the controller 110 performs image forming to complete processing of the printing job. The printed document is output to the output tray 107. Since the user requesting for secured printing is already at the place where the image forming apparatus 1 is provided, the printed document is most likely to be picked up by the user in a timely manner.

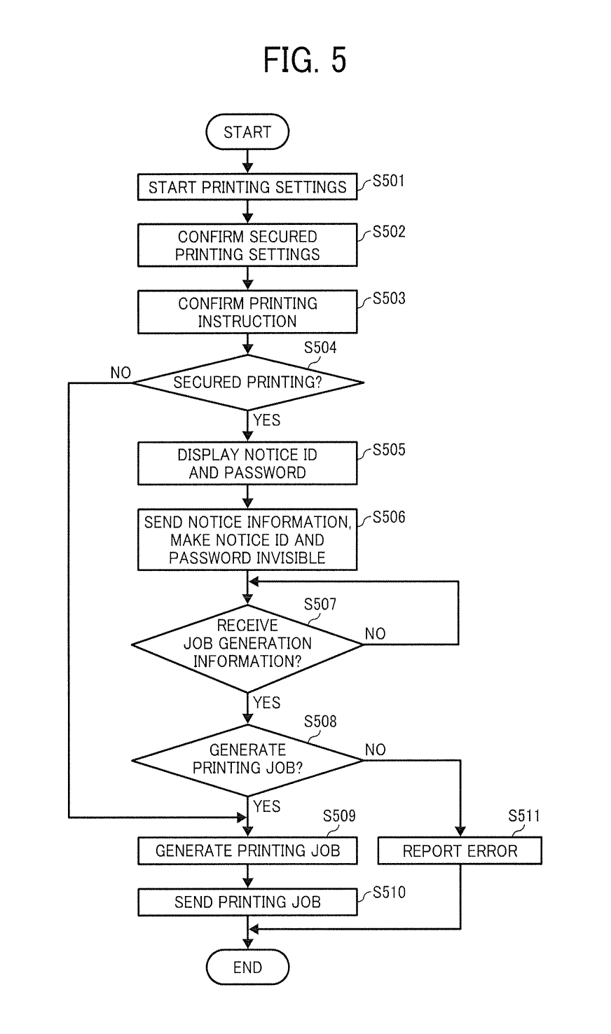

Referring now to FIG. 5, operation of generating a printing job, performed by the information processing apparatus 2, is explained according to an example embodiment of the present invention. The operation of FIG. 5 may be mainly performed by the printer driver 207 under control of the main controller 201.

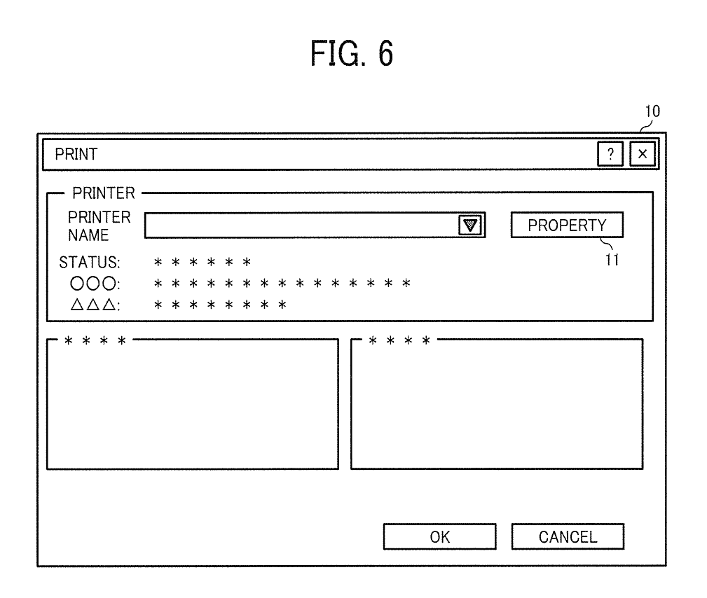

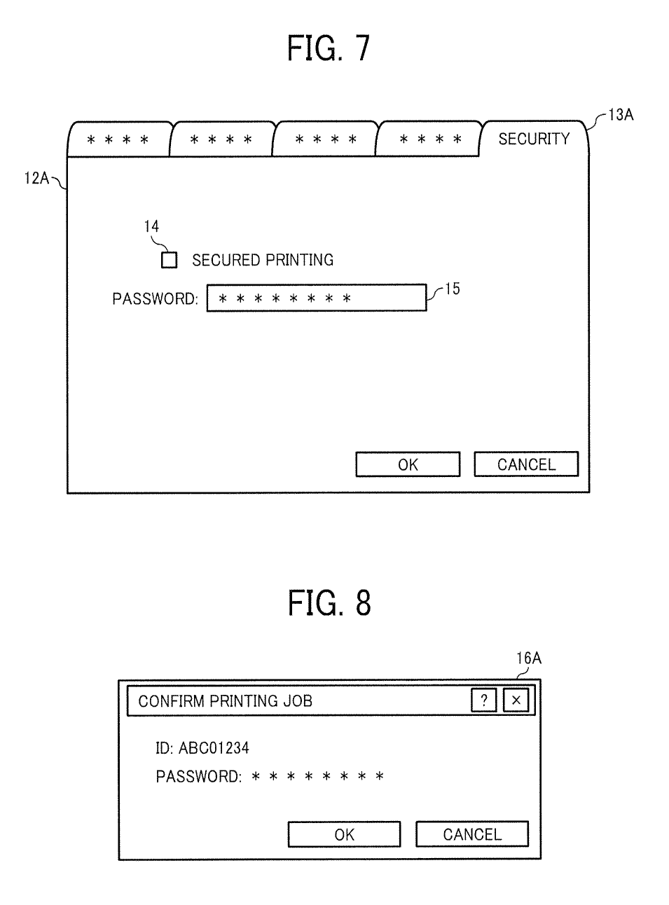

S501 starts printing preparation, for example, by allowing the user to confirm or change the printing settings including the settings regarding the secured printing function. In this example, it is assumed that document data or image data to be printed is displayed on the user I/F 204 by the application 206, which runs on an operation system of the information processing apparatus 2. When a user instruction for requesting preparation for printing the data being displayed is received through the application 206, the application 206 displays a printer dialog 10 illustrated in FIG. 6 on the user I/F 204. Using the printer dialog 10, the user may set various information regarding a printing job, such as a printer to perform a printing job, a page to be printed, etc. In order to confirm or change the settings regarding the secured printing function, the user may select a desired printer by displaying the printer name of the desired printer as shown in FIG. 6. The user may further select the “PROPERTY” button 11, which is provided in the printer dialog 10 to call the printer driver 207 of the selected printer. When the “PROPERTY” button 11 is selected, the printer driver 207 may display a printer driver dialog 12A illustrated in FIG. 7 on the user I/F 204 in replace of or in addition to the printer dialog 10 shown in FIG. 6. The printer driver dialog 12A includes a plurality of tabs including a “SECURITY” tab 13A.

The “SECURITY” tab 13A allows the user to determine the settings of secured printing. Referring to FIG. 7, the “SECURITY” tab 13A may include a secured printing selection box 14, a password section 15, an “OK” button, and a “CANCEL” button. The secured printing selection box 14 allows the user to select whether to perform a printing job using the secured printing function or to perform a printing job in a usual manner. The user may check the secured printing selection box 14 to select the secured printing function. The password section 15 allows the user to enter a password, which may be used to authenticate the user when the secured printing function is selected.

When the “OK” button of the “SECURITY” tab 13A is selected by the user, at S502, the printer driver 207 confirms that the settings regarding the secured printing are completed, and closes the printer driver dialog 12A. Alternatively, the printer driver dialog 12A may be switched to the printer dialog 10, for example, when the printer driver dialog 12A is displayed in replace of the printer dialog 10.

Referring to FIG. 6, when the “OK” button of the printer dialog 10 is selected by the user, at S503, the application 206 confirms that the instruction for printing is input. At this time, the application 206 may notify the printer driver 207 that the instruction for printing is received under control of the controller 210.

At S504, the printer driver 207 determines whether the secured printing function is selected by the user at S502. When it is determined that the secured printing function is selected (“YES” at S504), the operation proceeds to S505. When it is determined that the secured printing function is not selected (“NO” at S504), the operation proceeds to S509 to generate a printing job, and further to S510 to send the printing job.

At S505, the printer driver 207 generates a notice ID, which may be randomly generated with respect to the printing job to be generated. Further, the printer driver 207 obtains the password previously set at S502. The controller 201, which may be requested by the printer driver 207, causes the user I/F 204 to display a confirmation dialog, such as a confirmation dialog 16A shown in FIG. 8. Referring to FIG. 8, the confirmation dialog 16A includes the notice ID, the password, the “OK” button, and the “CANCEL” button. In this example, the password may be concealed with a predetermined mark as illustrated in FIG. 8. Alternatively, the password section displaying the password may not be provided in the confirmation dialog 16A. By concealing or not providing the password, the password may be protected from any other unauthorized user, who may otherwise be able to obtain the password by viewing the display. Alternatively, the password may be displayed to the user at least for a predetermined time period. The display of the password may remind the user of the password previously set.

When the “OK” button of the confirmation dialog 16A is selected by the user, at S506, the printer driver 207 generates printing job notice information. In this example, the printing job notice information includes a command that secured printing is requested, and the notice ID being generated and displayed at S505. The printing job notice information may additionally include any other desired information, including user identification information and/or password, as described above referring to FIG. 4. The controller 201 sends the printing job notice information, or a printing job notice signal, to the image forming apparatus 1 through the network I/F 203.

Further, at S506, the printer driver 207 may cause information regarding the notice ID and the password, which is displayed at S505, to be invisible. Alternatively, when the password is already concealed or not displayed, the notice ID is made invisible. For example, the confirmation dialog 16A shown in FIG. 8 may be closed. In another example, the section in which the user ID is displayed and the section in which the password is displayed may be concealed, while keeping the other buttons, such as the “CANCEL” button, selectable. In this example, the notice ID and the password may be made invisible at the time or shortly after when the user selects the “OK” button of the confirmation dialog 16A. By making the notice ID and the password invisible, any person other than the authorized user is prohibited from obtaining information regarding the notice ID and/or the password, even after the user leaves the information processing apparatus 2 to obtain a printed document.

At S507, the controller 201 determines whether printing job generation information is received from the image forming apparatus 1 through the network I/F 203. When it is determined that the printing job generation information is received (“YES” at S507), the operation proceeds to S509. When it is determined that the printing job generation information is not received (“NO” at S507), the operation repeats S507.

At S508, the printer driver 207 analyzes the printing job generation information to determine whether to generate the printing job. When it is determined that the printing job should be generated (“YES” at S508), the operation proceeds to S509. When it is determined that the printing job should not be generated (“NO” at S508), the operation proceeds to S511.

For example, the printing job generation information may include a message indicating that generation of the printing job is allowed. In such case, the printer driver 207 determines that the printing job should be generated, and the operation proceeds to S509. In another example, the printing job generation information may include a message indicating that generation of the printing job is not allowed. In such case, the printer driver 207 determines that the printing job should not be generated, and the operation proceeds to S511.

In another example, the printing job generation information may include a password or any other user authentication information input by the user through the operation panel 104 of the image forming apparatus 1. In such case, the printer driver 207 determines whether the password input by the user matches the password previously set by the user. When it is determined that the password input by the user matches the password previously set by the user, the printer driver 207 determines that the printing job should be generated, and the operation proceeds to S509. When it is determined that the password input by the user does not match the password previously set by the user, the printer driver 207 determines that the printing job should not be generated, and the operation proceeds to S511.

At S509, the printer driver 208 generates the printing job according to the settings previously set by the user. The printer job may include information regarding data to be output.

At S510, the main controller 201 sends the printing job through the network I/F 203, and the operation ends.

When it is determined that the printing job should not be generated at S508 (“NO” at S508), the operation proceeds to S511 to send an error message to the image forming apparatus 1 through the network I/F 203, and the operation ends.

The operation of FIG. 5 may be performed in various other ways. For example, at S505, instead of displaying at least the notice ID, the information processing apparatus 2 may request the user to insert a removable memory without displaying the notice ID, and when the removable memory is detected store at least the notice ID in the removable memory. Since the notice ID is not displayed, the notice ID may be prevented from being viewed by an unauthorized user more easily. Further, since the user does not have to remember the notice ID, the usability may improve. The removable memory may be implemented by a user ID card, which may be generated using the Radio Frequency Identification (RFID) card. The user ID card may store any other desired information, which may be useful to authenticate the user, such as the user ID and the password.

In another example, at S511, the operation may return to S507 at least for a predetermined number of times to expect to receive the printing job generation information, which indicates to generate the printing job.

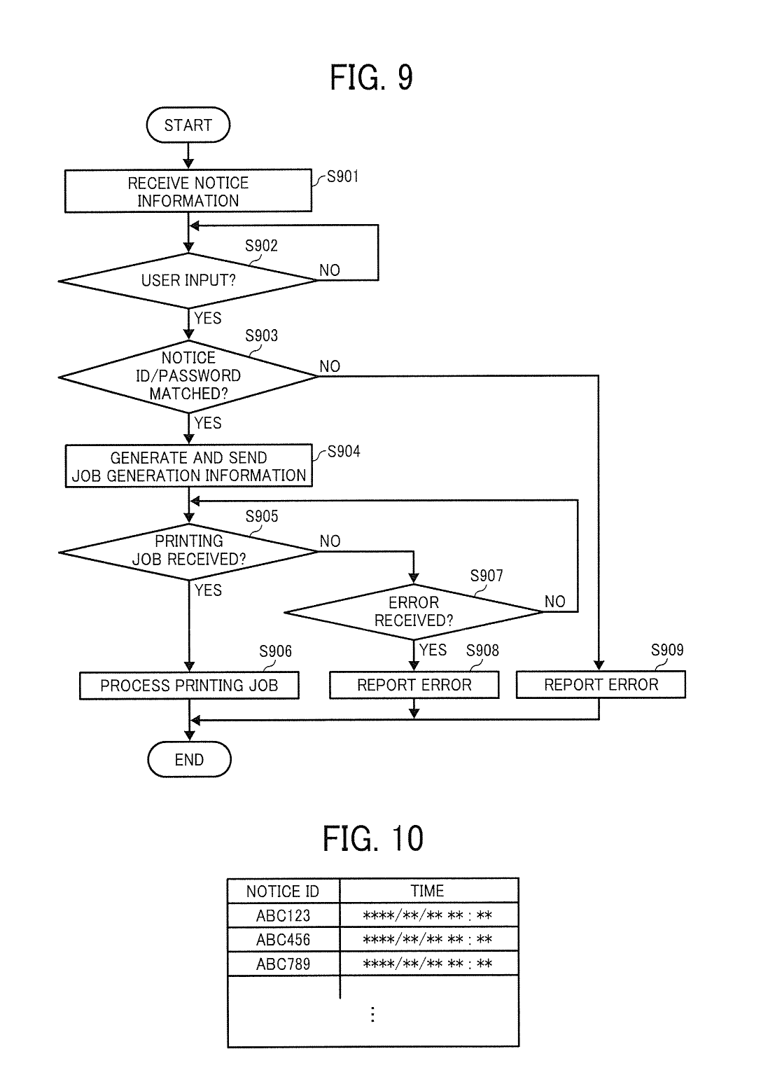

Referring now to FIG. 9, operation of controlling processing of a secured printing job is explained according to an example embodiment of the present invention. The operation of FIG. 9 may be performed by the controller 110 of the image forming apparatus 1.

S901 receives the printing job notice information, which may be generated and sent by the information processing apparatus 2 at S506 of FIG. 5, from the information processing apparatus 2 through the network I/F 108. When the printing job notice information is received, the controller 110 may store desired information obtained from the printing job notice information, for example, as the secured printing table shown in FIG. 10 as described above referring to FIG. 4. The secured printing table stores at least the notice ID, which may be used to identify the printing job to be generated. Further, the secured printing table may not only store the notice ID received from the information processing apparatus 2, but also the notice ID received from any other apparatus such as the information processing apparatus 3.

S902 determines whether the operation panel 104 receives a user input, including the notice ID and the password. The user is assumed to obtain at least the notice ID from the information processing apparatus 2 at S505 of FIG. 5. When it is determined that the user input is received (“YES” at S902), the operation proceeds to S903. When it is determined that the user input is not received (“NO” at S903), the operation repeats S902.

S903 determines whether the notice ID and/or password obtained from the user input matches the notice ID and/or password obtained from the printing job notice information to generate a determination result, for example, by referring to the secured printing table generated at S901. When the determination result indicates that the notice ID and/or password of the user input matches the notice ID and/or password of the printing job notice information (“YES” at S903), the operation proceeds to S904. When the determination result indicates that the notice ID and/or password of the user input does not match the notice ID and/or password of the printing job notice information (“NO” at S903), the operation proceeds to S909.

S904 generates printing job generation information based on the determination result obtained at S903, and send the printing job generation information to the information processing apparatus 2. At S904, the controller 110 generates the printing job generation information, which includes at least a message that generation of the printing job is allowed. The printing job generation information may additionally include the password of the user input.

S905 determines whether the printing job is received from the information processing apparatus 2 through the network I/F 203. When it is determined that the printing job is received (“YES” at S905), the operation proceeds to S906. When it is determined that the printing job is not received (“NO” at S905), the operation proceeds to S907.

S906 processes the printing job received from the information processing apparatus 2, and the operation ends.

S907 determines whether an error message indicating that generation of the printing job is not allowed is received from the information processing apparatus 2, which may be generated by the information processing apparatus 2 at S511 of FIG. 5. When it is determined that the error message is received from the information processing apparatus 2 (“YES” at S907), the operation proceeds to S908 to display an error message on the operation panel 104, and the operation ends. At S908, any information relating to the notice ID and/or the password subjected to error may be deleted, for example, from the secured printing table. When it is determined that the error message is not received from the information processing apparatus 2 (“NO” at S907), the operation returns to S905.

When it is determined that the notice ID and/or the password of the user input does not match the notice ID and/or the password of the printing job notice information (“NO” at S903), at S909, the controller 110 generates the printing job generation information, which indicates generation of the printing job is not allowed, and sends the printing job generation information including the message that generation of the printing job is not allowed to the information processing apparatus 2. Further, at S909, the controller 110 causes the operation panel 104 to display an error message, and the operation ends. At S909, any information relating to the notice ID and/or the password subjected to error may be deleted, for example, from the secured printing table.

The operation of FIG. 9 may be performed in various other ways. For example, the user input, which is received at S902, may only include the password, as long as the printing job to be generated can be identified. For example, the image forming apparatus 1 may request the user to input a user ID through the operation panel 104 or a select one of a plurality of user names or user IDs that may be displayed through the operation panel 104. When the user requesting for the secured printing job is identified, the image forming apparatus 1 may request the user to input a password previously set by the user, for example, through the “SECURITY” tab 13A of FIG. 7. When the user input including the password is received, the image forming apparatus 1 may determine whether any notice ID that corresponds to the user has been received, for example, by referring to the secured printing table 10. When more than one notice ID is found, the image forming apparatus 1 may request the user to select one or more than one jobs through the operation panel 104. Once the printing job, which may be more than one, is identified, the image forming apparatus 1 may determine whether the printing job notice information includes the password. When the password can be obtained from the printing job notice information, the image forming apparatus 1 may determine whether the password of the user input matches the password obtained from the printing job notice information to generate a determination result. When the password is not obtainable from the printing job notice information, the image forming apparatus may send the password to the information processing apparatus 2 at S904 to request the information processing apparatus 2 to check the password. With this configuration, the user is not required to input the notice ID, which may be difficult to remember, every time the user desires to use the secured printing function. Further, even when the user requests more than one printing job at different times, the user is able to instruct the image forming apparatus 1 to process any desired number of printing jobs or any desired printing job.

In another example, at S902, the user input does not have to be received through the operation panel 104. For example, the user may be provided with the removable memory such as the user ID card as described above referring to FIG. 5. The user ID card may store various information, which may be used to authenticate the user, such as the user ID and the password set by the user with respect to the user ID. The user ID card may additionally store the notice ID as described above referring to FIG. 5. The image forming apparatus 1 may read out information stored in the user ID card, and authenticate using the information being read from the user ID card.

In another example, at S908 and/or S909, in addition to the error message, the image forming apparatus 1 may request the user to re-enter the notice ID and/or the password at least for a predetermined number of times.

As described above referring to FIGS. 4 to 10, the printing job is generated only when the user, who is authenticated, inputs the instruction to the image forming apparatus 1. With this configuration, the printing job is assumed to be sent immediately after it is generated, thus preventing the printing job to be stored in the information processing apparatus 2 for long time. Further, since the printing job will be most likely to be generated after the user makes the final decision to use the secured printing function, canceling the secured printing job may be easily performed, for example, when the user decides to cancel after completing the settings for secured printing but before leaving the information processing apparatus 2 to obtain the printed document.

Further, the user is allowed to select whether to use the secured printing function, by simply checking the secured printing selection box 14 as described above referring to FIG. 7. With this configuration, the user may be encouraged to select the secured printing function only when it is necessary. This may prevent the user from leaving the secured printing job to be unprocessed for long time.

Further, the image forming apparatus 1 receives the printing job only when the user, who is authenticated, inputs the instruction to the image forming apparatus 1. Since information being stored in the image forming apparatus 1 is the printing job notice information, which is relatively small in data size compared to the data size of the printing job, the memory space of the image forming apparatus 1 may be used more efficiently. Further, since the printing job notice information, such as the notice ID, does not contain any confidential information at least by itself, the security level of the image forming system may improve.

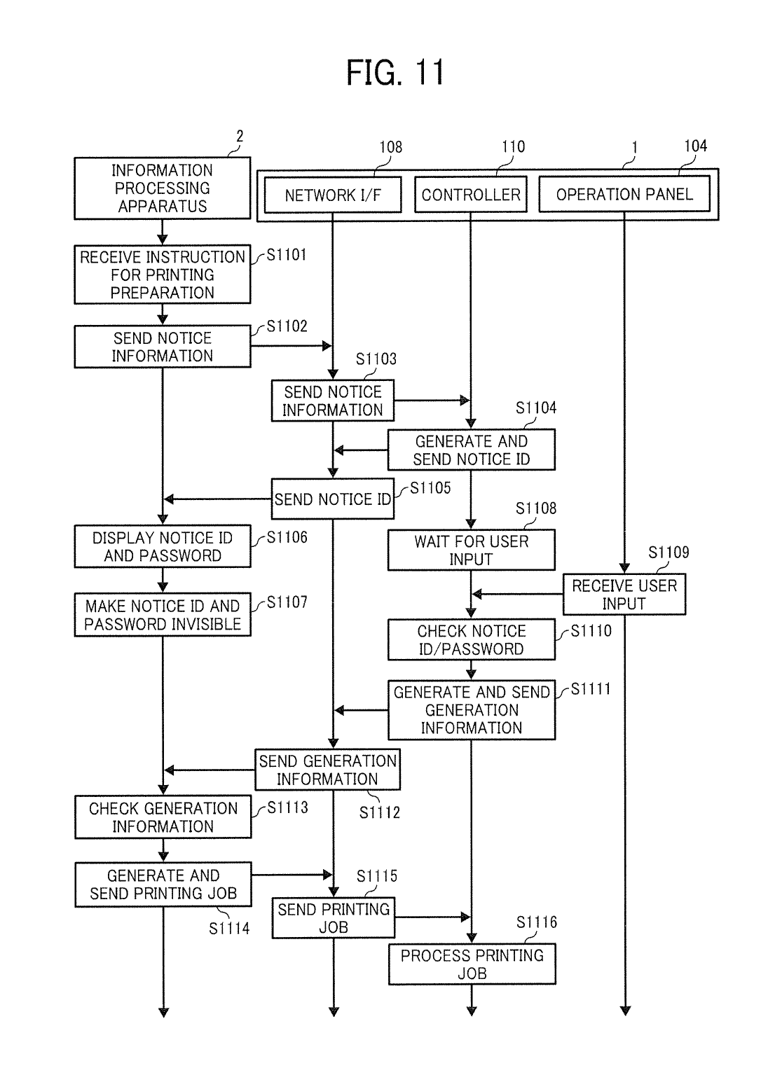

Referring now to FIG. 11, operation of generating a secured printing job and processing the secured printing job, performed by the image forming system of FIG. 1, is explained according to an example embodiment of the present invention. The operation of FIG. 11 may be performed in a substantially similar manner as described above referring to FIG. 4. Compared to the example case described above referring to FIGS. 4 to 10, the notice ID is generated by the image forming apparatus 1.

At S1101, the information processing apparatus 2 may receive a user instruction, which requests the printer driver 207 to prepare for printing job generation, through the application 206, in a substantially similar manner as described above referring to S400 of FIG. 4.

At S1102, the information processing apparatus 2 sends printing job notice information to the image forming apparatus 1. In this example, the printing job notice information includes a request for generating a notice ID (“notice ID request”). The printing job notice information may additionally include user identification information, such as the network address of the information processing apparatus 2.

At S1103, the image forming apparatus 1 receives the printing job notice information, which is sent from the information processing apparatus 2 at S1102, through the network I/F 108. The network I/F 108 sends the printing job notice information to the controller 110.

When the controller 110 receives the printing job notice information including the notice ID request, at S1104, the controller 110 generates a notice ID corresponding the printing job to be generated by the information processing apparatus 2, and sends the notice ID to the network I/F 108. The notice ID may be generated in a substantially similar manner as described above referring to S401 of FIG. 4.

At S1105, the network I/F 108 sends the notice ID to the information processing apparatus 2.

When the information processing apparatus 2 receives the notice ID generated by the image forming apparatus 1, at S1106, the information processing apparatus 2 displays the notice ID to the user, for example, through the user I/F 204. In this example, the password previously set may be additionally displayed.

At S1107, the information processing apparatus 2 makes the notice ID and the password, which are displayed at S1106, to be invisible from the user. The information processing apparatus 2 waits for further processing.

After sending the notice ID to the information processing apparatus 2, the controller 10 of the image forming apparatus 1 waits until the operation panel 104 receives a user input.

At S1109, the operation panel 104 receives the user input, which includes information regarding the notice ID and the password, and sends the obtained information to the controller 110.

At S1110, the controller 110 is activated to check the user input in a substantially similar manner as described above referring to S407 of FIG. 4.

At S1111, the controller 110 generates printing job generation information and sends the printing job generation information to the network I/F 108, in a substantially similar manner as described above referring to S408 of FIG. 4.

At S1112, the network I/F 108 sends the printing job generation information to the information processing apparatus 2 via the network 4, in a substantially similar manner as described above referring to S409 of FIG. 4.

At S1113, the information processing apparatus 2 determines whether to generate the printing job based on the printing job generation information, in a substantially similar manner as described above referring to S410 of FIG. 4.

At S1114, the information processing apparatus 2 generates the printing job, and sends the printing job to the image forming apparatus 1, in a substantially similar manner as described above referring to S411 of FIG. 4.

When the network I/F 108 receives the printing job, at S1115, the network I/F 108 sends the printing job to the controller 110.

At S1116, the controller 110 performs image forming to complete processing of the printing job in a substantially similar manner as described above referring to S413 of FIG. 4

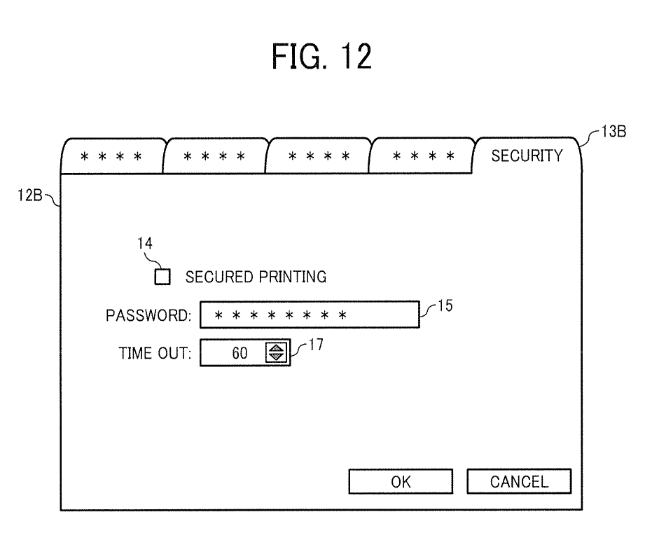

Referring now to FIGS. 12 to 15, operation of generating a secured printing job and processing the secured printing job, performed by the image forming system of FIG. 1, is explained according to an example embodiment of the present invention. Compared to the example case described above referring to FIGS. 4 to 10, the image forming apparatus 1 may additionally determine whether the user input is received within a timeout period previously set, and requests the information processing apparatus 2 to generate the printing job when it is determined that the user input is received within a timeout period previously set.

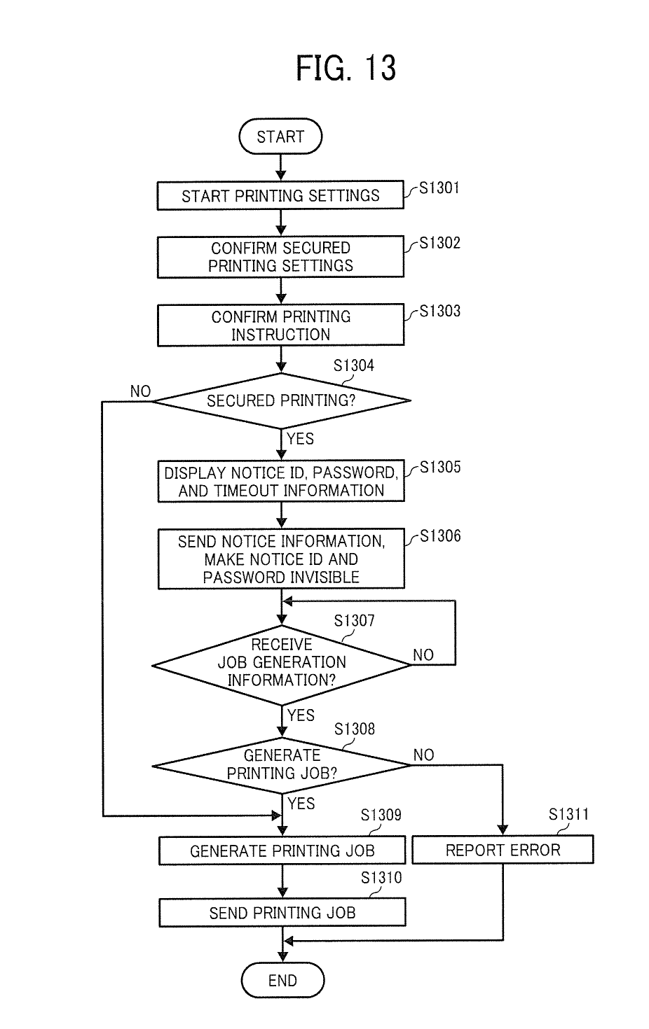

Referring now to FIG. 13, operation of generating a printing job, performed by the information processing apparatus 2, is explained according to an example embodiment of the present invention.

S1301 starts printing preparation in a substantially similar manner as described above referring to S501 of FIG. 5. However, in this example, when the user selects the “PROPERTY” button 11 of the printer dialog 10 shown in FIG. 6, the printer driver 207 may display a printer driver dialog 12B illustrated in FIG. 12 on the user I/F 204 in replace or in addition to the printer dialog 10 shown in FIG. 6. The printer driver dialog 12B includes a plurality of tabs including a “SECURITY” tab 13B.

The “SECURITY” tab 13B, which allows the user to determine the settings of secured printing, includes the secured printing selection box 14, the password section 15, a timeout section 17, the “OK” button, and the “CANCEL” button. The timeout section 17 allows the user to enter timeout information, which may be used to restrict a time in which the user can input the instruction to process the secured printing job.

When the “OK” button of the “SECURITY” tab 13B is selected by the user, at S1302, the printer driver 207 confirms that the settings regarding the secured printing are completed, and closes the printer driver dialog 12B, in a substantially similar manner as described above referring to S502 of FIG. 5.

When the “OK” button of the printer dialog 10 is selected by the user, at S1303, the application 206 confirms that the instruction for printing is input in a substantially similar manner as described above referring to S503 of FIG. 5.

S1304 determines whether the secured printing function is selected by the user at S1302. When it is determined that the secured printing function is selected (“YES” at S1304), the operation proceeds to S1305. When it is determined that the secured printing function is not selected (“NO” at S1304), the operation proceeds to S1309 to generate a printing job, and further to S1310 to send the printing job.

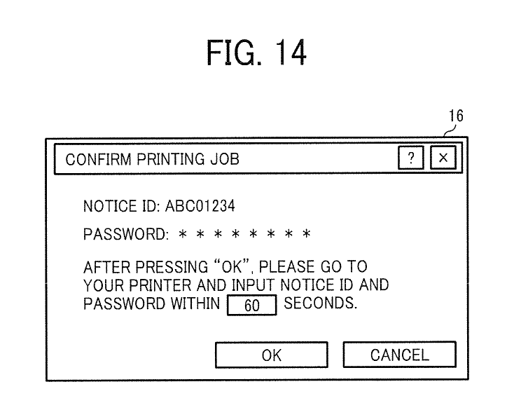

At S1305, the printer driver 207 generates a notice ID, which may be randomly generated with respect to the printing job to be generated. Further, the printer driver 207 obtains the password and the timeout information, each of which is previously set at S1302. The controller 201 causes the user I/F 204 to display a confirmation dialog, such as a confirmation dialog 16B shown in FIG. 14. Referring to FIG. 14, the confirmation dialog 16B includes the notice ID, the password, the “OK” button, the “CANCEL” button, and a message indicating that the user is required to input the notice ID and the password to the image forming apparatus 1 to obtain the printed document within a timeout period set by the user.

When the “OK” button of the confirmation dialog 16B is selected by the user, at S1306, the printer driver 207 generates printing job notice information. In this example, the printing job notice information includes a command that secured printing is requested, the notice ID and the timeout information. The printing job notice information may additionally include any other desired information, including user identification information such as user ID and/or password. The controller 201 sends the printing job notice information, or a printing job notice signal, to the image forming apparatus 1 through the network I/F 203.

Further, at S1306, the printer driver 207 may cause information regarding the notice ID and the password, which is displayed at S1305, to be invisible. In this example, the section in which the user ID is displayed and the section in which the password is displayed may be concealed at the time or shortly after when the user selects the “OK” button of the confirmation dialog 16B.

S1307 determines whether printing job generation information is received from the image forming apparatus 1 through the network I/F 203. When it is determined that the printing job generation information is received (“YES” at S1307), the operation proceeds to S1308. When it is determined that the printing job generation information is not received (“NO” at S1307), the operation repeats S1307.

At S1308, the printer driver 207 analyzes the printing job generation information to determine whether to generate the printing job, for example, as described above referring to S508 of FIG. 5. When it is determined that the printing job should be generated (“YES” at S1308), the operation proceeds to S1309. When it is determined that the printing job should not be generated (“NO” at S1308), the operation proceeds to S1311.

S1309 generates the printing job, in a substantially similar manner as described above referring to S509 of FIG. 5.

S1310 sends the printing job through the network I/F 203, and the operation ends.

When it is determined that the printing job should not be generated at S1308 (“NO” at S1308), the operation proceeds to S1311 to send an error message to the image forming apparatus 1 through the network I/F 203, and the operation ends.

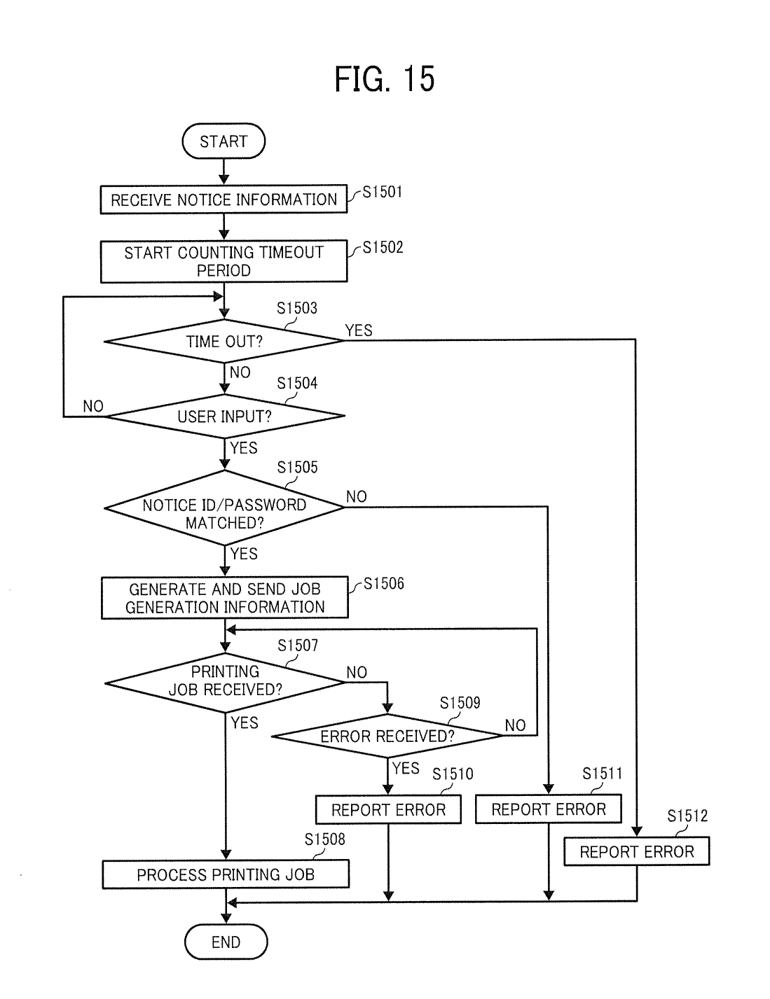

Referring now to FIG. 15, operation of controlling processing of a secured printing job is explained according to an example embodiment of the present invention. The operation of FIG. 15 may be performed by the controller 110 of the image forming apparatus 1.

S1501 receives the printing job notice information from the information processing apparatus 2 through the network I/F 108. In this example, the printing job notice information, which may be generated at S1306 of FIG. 13, includes the command requesting the secured printing, the notice ID and the timeout information. When the printing job notice information is received, the controller 110 may store desired information obtained from the printing job notice information, for example, as the secured printing table shown in FIG. 10 as described above referring to FIG. 4. The secured printing table stores at least the notice ID and the timeout information.

S1502 starts counting a timeout period to obtain a counted timeout period.

S1503 determines whether the counted timeout period reaches a previously set timeout period, or the timeout information, obtained from the printing job notice information. When it is determined that the counted timeout period reaches the previously set timeout period (“YES” at S1503), the operation proceeds to S1512 to report an error. When it is determined that the counted time period does not reach the previously set timeout period (“NO” at S1503), the operation proceeds to S1504.

S1504 determines whether the operation panel 104 receives a user input, including the notice ID and the password. The user is assumed to obtain at least the notice ID from the information processing apparatus 2 at S1305 of FIG. 13. When it is determined that the user input is received (“YES” at S1504), the operation proceeds to S1505. When it is determined that the user input is not received (“NO” at S1504), the operation returns to S1503.

S1505 determines whether the notice ID and/or password obtained from the user input matches the notice ID and/or password obtained from the printing job notice information to generate a determination result, for example, by referring to the secured printing table generated at S1501. When the determination result indicates that the notice ID and/or password of the user input matches the notice ID and/or password of the printing job notice information (“YES” at S1505), the operation proceeds to S1506. When the determination result indicates that the notice ID and/or password of the user input does not match the notice ID and/or password of the printing job notice information (“NO” at S1505), the operation proceeds to S1511.

S1506 generates printing job generation information based on the determination result obtained at S1505, and send the printing job generation information to the information processing apparatus 2. At S1506, the controller 110 generates the printing job generation information, which includes at least a message that generation of the printing job is allowed. The printing job generation information may additionally include the password of the user input.

S1507 determines whether the printing job is received from the information processing apparatus 2 through the network I/F 203. When it is determined that the printing job is received (“YES” at S1507), the operation proceeds to S1508. When it is determined that the printing job is not received (“NO” at S1507), the operation proceeds to S1509.

S1508 processes the printing job received from the information processing apparatus 2, and the operation ends.

S1509 determines whether an error message indicating that generation of the printing job is not allowed is received from the information processing apparatus 2, which may be generated by the information processing apparatus 2 at S1311 of FIG. 13. When it is determined that the error message is received from the information processing apparatus 2 (“YES” at S1509), the operation proceeds to S1510 to display an error message on the operation panel 104, and the operation ends. At S1510, any information relating to the notice ID and/or password subjected to error may be deleted, for example, from the secured printing table. When it is determined that the error message is not received from the information processing apparatus 2 (“NO” at S1509), the operation returns to S1507.

When the counted timeout period reaches the previously set timeout period (“YES” at S1503), at S1512, the controller 110 generates the printing job generation information, which indicates generation of the printing job is not allowed, and sends the printing job generation information to the information processing apparatus 2. Further, at S1512, the controller 110 causes the operation panel 104 to display an error message, and the operation ends. At S1512, any information relating to the notice ID and/or password subjected to error may be deleted, for example, from the secured printing table.

When it is determined that the notice ID and/or password of the user input does not match the notice ID and/or password of the printing job notice information (“NO” at S1505), at S1511, the controller 110 generates the printing job generation information, which indicates generation of the printing job is not allowed, and sends the printing job generation information to the information processing apparatus 2. Further, at S1511, the controller 110 causes the operation panel 104 to display an error message, and the operation ends. At S1511, any information relating to the notice ID and/or password subjected to error may be deleted, for example, from the secured printing table.

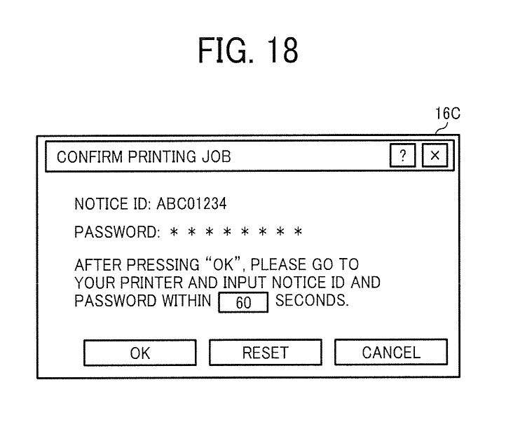

The operation of FIGS. 12 to 15 may be performed in various other ways. For example, at S1305 of FIG. 13, the printer driver 207 may display a confirmation dialog 16C shown in FIG. 18, which additionally includes a “RESET” button. The “RESET” button allows the user to reset counting a timeout period even after the “OK” button is pressed. For example, after selecting the “OK” button, the user may select the “RESET” button of the confirmation dialog 16C to reset the timeout period. When the selection of the RESET” button is detected, the information processing apparatus 2 may request the image forming apparatus 1 to reset the counted time period. With this function of resetting the timeout period, the user may be able to adjust the timeout period without canceling the secured printing job, for example, when the user encounters the unexpected situation that prohibits the user from going to the place where the image forming apparatus 1 is provided.

In another example, the printer driver 207 may display a printer driver dialog having a “SECURITY” tab, which additionally includes a timeout selection box. The timeout selection box allows the user to select or not select the function of restricting the time to process the printing job.

In another example, the user ID may be generated by the image forming apparatus 1, for example, as described above referring to FIG. 11.

In another example, S1502 of counting and S1503 may be performed by the information processing apparatus 2.

As described above referring to FIGS. 12 to 15, the printing job is generated only when the user, who is authenticated, inputs the instruction to the image forming apparatus 1 within a timeout period previously set. With this configuration, the user is encouraged to go to the place where the image forming apparatus 1 is provided to process the printing job within the previously set timeout period. Since the printing job notice information will not be stored for a time period longer than the previously set timeout period, the memory space of the image forming apparatus 1 and/or the information processing apparatus 2 may be used more efficiently. Further, since the printing job notice information will not be stored for a time period longer than the previously set timeout period, the security level of the image forming system may improve.

For example, the timeout information may be previously set by an administrator according to the security policy, rather than by the individual user. By lowering the value of timeout period, the administrator may almost force the individual user to process the printing job immediately after the user requests the information processing apparatus 2 to print a document with the security printing function.

Further, with the timeout period being set, the administrator of the image forming system may only require the user to input the password to the image forming apparatus 1 rather than requiring the user to input the notice ID. The use of notice ID for user authentication may be recommended since it is more complicated than the password. However, with the timeout period being set, the password, which tends to be simpler, may be able to provide the security level relatively high. This may increase usability, as the user only needs to input the password, which should be easy to remember.

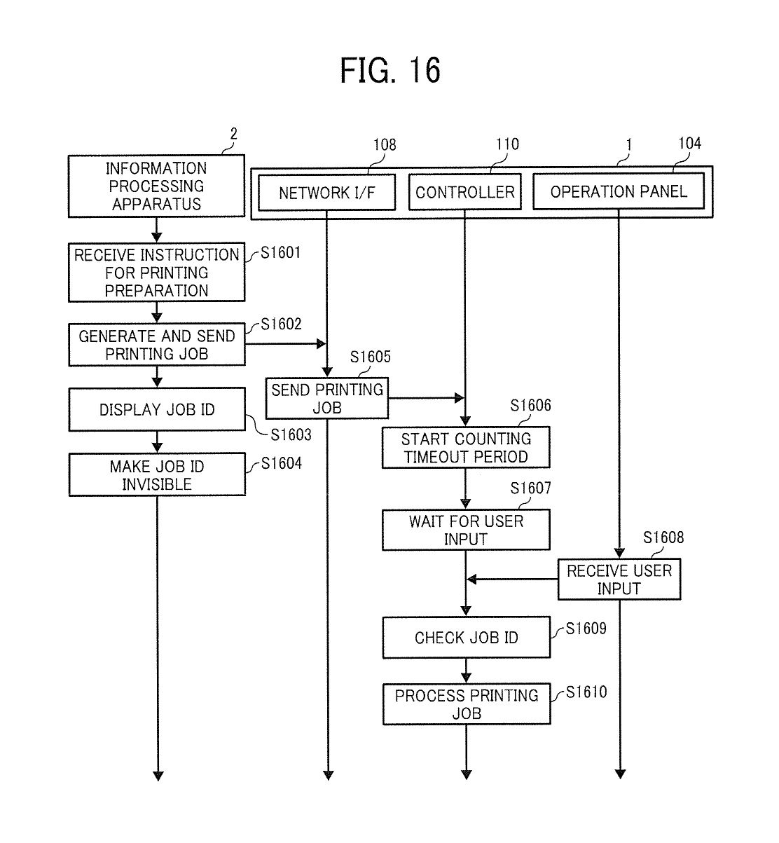

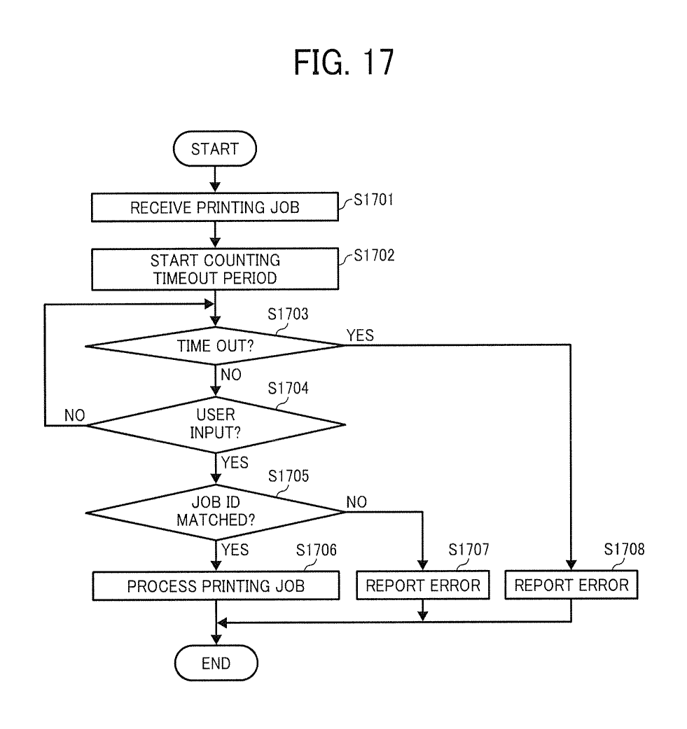

Referring now to FIGS. 16 and 17, operation of generating a secured printing job and processing the secured printing job, performed by the image forming system of FIG. 1, is explained according to an example embodiment of the present invention.

At S1601, the information processing apparatus 2 may receive a user instruction, which requests the printer driver 207 to prepare for printing job generation, through the application 206.

At S1602, the information processing apparatus 2 generates a printing job according to the user instruction, and a job ID that is assigned to the printing job. Further, the information processing apparatus 2 obtains timeout information previously set, for example, in a substantially similar manner as described above referring to FIG. 13. The information processing apparatus 2 sends the printing job, which includes data to be printed, together with at least the job ID and the timeout information to the image forming apparatus 1 via the network 4.

At S1603, the information processing apparatus 2 displays at least the job ID to the user through the user I/F 204.

At S1604, the information processing apparatus 2 makes the job ID, which is displayed at S1603, to be invisible from the user.

At S1605, the image forming apparatus 1 receives the printing job, which is sent from the information processing apparatus 2 at S1602, through the network I/F 108. The network I/F 108 sends the printing job to the controller 110.

At S1606, the controller 110 receives the printing job, and stores the printing job, for example, in the form of secured job table. Further, the controller 110 starts counting a timeout period to obtain a counted time period.

At S1607, the controller 110 waits until the operation panel 104 receives a user input or until the counted timeout period reaches a previously set time period obtained from the timeout information.

The user, who has obtained information regarding the job ID from the user I/F 104 at S1603, moves to the place where the image forming apparatus 1 is provided. Through the operation panel 104, the user may input the job ID. At S1608, the operation panel 104 receives the user input, which includes information regarding the job ID, and sends the obtained information to the controller 110.

When the user input is detected through the operation panel 104, at S1609, the controller 110 is activated to check the user input. In one example, the controller 110 may determine whether the job ID of the user input, which is obtained at S1608, matches the job ID obtained from the information processing apparatus 1, for example, by checking the secured job table to generate a determination result.

At S1610, the controller 110 performs image forming to complete processing of the printing job.

Referring now to FIG. 17, operation of controlling processing of a secured printing job is explained according to an example embodiment of the present invention. The operation of FIG. 17 may be performed by the controller 110 of the image forming apparatus 1.

S1701 receives the printing job, which may be generated and sent by the information processing apparatus 2 at S1601 of FIG. 16, from the information processing apparatus 2 through the network I/F 108. As described above referring to FIG. 16, the printing job may be stored in the secured printing table.

S1702 starts counting a timeout period to obtain a counted timeout period.

S1703 determines whether the counted timeout period reaches a previously set timeout period, or the timeout information, obtained from the printing job notice information. When it is determined that the counted timeout period reaches the previously set timeout period (“YES” at S1703), the operation proceeds to S1708 to report an error. When it is determined that the counted time period does not reach the previously set timeout period (“NO” at S1703), the operation proceeds to S1704.

S1704 determines whether the operation panel 104 receives a user input, including the job ID. When it is determined that the user input is received (“YES” at S1704), the operation proceeds to S1705. When it is determined that the user input is not received (“NO” at S1704), the operation returns to S1703.

S1705 determines whether the job ID obtained from the user input matches the job ID obtained from information processing apparatus 2 at S1701 to generate a determination result, for example, by referring to the secured printing table generated at

S1701. When the determination result indicates that the job ID of the user input matches the job ID being obtained (“YES” at S1705), the operation proceeds to S1706. When the determination result indicates that the job ID of the user input does not match the job ID being obtained (“NO” at S1705), the operation proceeds to S1707.

S1706 processes the printing job received from the information processing apparatus 2, and the operation ends.

When the counted timeout period reaches the previously set timeout period (“YES” at S1703), at S1708, the controller 110 generates the printing job generation information, which includes a message that indicates generation of the printing job is not allowed, and sends the printing job generation information to the information processing apparatus 2. Further, at S1708, the controller 110 causes the operation panel 104 to display an error message, and the operation ends. At S1708, any information relating to the job ID subjected to error may be deleted, for example, from the secured printing table.

When it is determined that the job ID of the user input does not match the job ID being obtained (“NO” at S1705), at S1707, the controller 110 generates the printing job generation information, which includes a message that indicates generation of the printing job is not allowed, and sends the printing job generation information to the information processing apparatus 2. Further, at S1707, the controller 110 causes the operation panel 104 to display an error message, and the operation ends. At S1707, any information relating to the job ID subjected to error may be deleted, for example, from the secured printing table.

The operation of FIG. 17 may be performed in various other ways. For example, S1705 of determining may be performed based on information other than the job ID, such as the password input by the user, in addition to the job ID. In such case, the image forming apparatus 1 may receive the password previously set by the user from the information processing apparatus 2. Alternatively, the image forming apparatus 1 may send the password obtained from the user input to the information processing apparatus 2 to request the information processing apparatus 2 to determine whether the password of the user input matches the password previously set by the user. Further, the user input, which is received at S1704, may only include the password, as long as the printing job to be generated can be identified.

As described above referring to FIGS. 16 and 17, the printing job, which is stored in the image forming apparatus 1, will be deleted when the counted timeout period reaches the previously set timeout period. With this configuration, the user may be encouraged to go to the place where the image forming apparatus 1 is provided to process the printing job within the previously set timeout period. Since the printing job will not be stored for a time period longer than the previously set timeout period, the memory space of the image forming apparatus 1 may be used more efficiently while improving the security level of the image forming system. Further, since the image forming apparatus 1 does not have to request the information processing apparatus 2 to generate and send the printing job, the overall processing speed may be reduced.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

What is claimed is:

1. An image forming apparatus, comprising:
a network interface to receive printing job notice information from an outside apparatus via a network, the printing job notice information being generated by the outside apparatus when a user instruction for generating a printing job is received at the outside apparatus;
a user interface to receive a printing job execution instruction from a user; and
a controller to determine whether the printing job execution instruction matches the printing job notice information to generate a first determination result, generate printing job generation information including a message that indicates whether to generate the printing job based on the first determination result, and send the printing job generation information to the outside apparatus via the network.

2. The apparatus of claim 1, wherein:
the printing job notice information includes timeout information being previously set, and wherein:
the controller is further configured to determine whether the printing job execution instruction is received within a time period set by the timeout information to generate a second determination result,
the printing job generation information being generated based on the second determination result in addition to the first determination result.

3. The apparatus of claim 2, wherein:
the controller is further configured to store at least a part of the printing job notice information with respect to job identification information being assigned to the printing job,
the job identification information being generated by at least one of the image forming apparatus and the outside apparatus.

4. The apparatus of claim 3, wherein:
the first determination result is generated based on whether job identification information obtained from the printing job execution instruction matches the job identification information being stored in the image forming apparatus, and wherein:
the controller is further configured to send user authentication information obtained from the printing job execution instruction to the outside apparatus as a part of the printing job generation information, and receive the printing job from the outside apparatus when the outside apparatus determines that the user authentication information obtained from the printing job execution instruction matches user authentication information previously set.

5. The apparatus of claim 4, wherein:
the controller is further configured to receive an error message from the outside apparatus, the error message being generated by the outside apparatus when the outside apparatus determines that the user authentication information obtained from the printing job execution instruction does not match the user authentication information previously set.

6. The apparatus of claim 3, wherein:
the first determination result is generated based on whether user authentication information obtained from the printing job execution instruction matches user authentication information previously set, and wherein:
the controller is further configured to receive the user authentication information previously set from the outside apparatus as a part of the printing job notice information.

7. The apparatus of claim 3, wherein:
the controller is further configured to delete the at least a part of the printing job notice information when the printing job generation information indicates not to generate the printing job.

8. An image forming system, comprising:
an information processing apparatus to send printing job notice information when a user instruction for generating a printing job is received; and
an image forming apparatus to receive the printing job notice information from the information processing apparatus and a printing job execution instruction from a user, determine whether the printing job execution instruction matches the printing job notice information to generate a first determination result, generate printing job generation information including a message that indicates whether to generate the printing job based on the first determination result, and send the printing job generation information to the information processing apparatus.

9. The system of claim 8, wherein:
the information processing apparatus is further configured to receive a user input including timeout information, and send the timeout information as a part of the printing job notice information, and wherein:
the image forming apparatus is further configured to determine whether the printing job execution instruction is received within a timeout period set by the timeout information to generate a second determination result,
the printing job generation information being generated based on the second determination result in addition to the first determination result.

10. The system of claim 9, wherein:
the information processing apparatus is further configured to display job identification information being assigned to the printing job at least for a limited time period, the job identification information being generated by at least one of the information processing apparatus and the image forming apparatus, and wherein:
the first determination result is generated based on whether job identification information obtained from the printing job execution instruction matches the job identification information being displayed to the user.

11. The system of claim 9, wherein:
the information processing apparatus is further configured to receive a user input including user authentication information, and wherein:
the image forming apparatus is further configured to obtain user authentication information from the printing job execution instruction,
the first determination result being generated based on whether the user authentication information obtained from the printing job execution instruction matches the user authentication information of the user input.

12. The system of claim 9, wherein:
the image forming apparatus is further configured to store at least a part of the printing job notice information when the printing job notice information is received, and delete the at least a part of the printing job notice information when the printing job generation information indicates not to generate the printing job.

13. The system of claim 9, wherein:
the information processing apparatus is further configured to receive a user input requesting resetting of the timeout period, and send a request for resetting the timeout period to the image forming apparatus, and wherein:
the image forming apparatus is further configured to reset counting of the timeout period.

14. A method of operating an image forming system, comprising:
sending printing job notice information from an information processing apparatus to an image forming apparatus when a user instruction for generating a printing job is received at the information processing apparatus;
receiving at the image forming apparatus a printing job execution instruction from a user;
generating at the image forming apparatus printing job generation information, the printing job information including a message that indicates whether to generate the printing job based on a first determination result, the first determination result indicating whether the printing job execution instruction matches the printing job notice information;
generating at the information processing apparatus the printing job based on the printing job generation information; and
forming at the image forming apparatus an image according to the printing job.

15. The method of claim 14, further comprising:
receiving at the information processing apparatus timeout information from the user;
sending the timeout information from the information processing apparatus to the image forming apparatus as a part of the printing job notice information;
determining whether the printing job execution instruction is received within a time period set by the timeout information to generate a second determination result,
wherein the printing job generation information is generated based on the second determination result in addition to the first determination result.

16. A computer readable recording medium including computer program instructions which cause a computer to execute a method of controlling an image forming operation, the method comprising:
displaying on a user interface at least one of a plurality of sections including:
a first section allowing the user to select the security printing function;
a second section allowing the user to input user authentication information;
a third section allowing the user to select the timeout function; and
a fourth section allowing the user to input timeout information,
sending printing job notice information when a user instruction for generating a printing job is received, the printing job notice information including information regarding the at least one of a plurality of sections being displayed;
receiving printing job generation information; and
generating the printing job based on the printing job generation information.
